(19) United States
(12) Patent Application Publication
(10) Pub. No.: US 2019/0340561 A1
(43) Pub. Date: Nov. 7, 2019

(54) SYSTEMS AND METHODS FOR CROSS-LOAD INTERMIXING DURING ORDER FULFILMENT

(71) Applicant: Walmart Apollo, LLC, Bentonville, AR (US)

(72) Inventors: Pratosh Rajkhowa, Bangalore (IN); Shekhar Gupta, Bangalore (IN)

(21) Appl. No.: 16/405,439

(22) Filed: May 7, 2019

Related U.S. Application Data
(60) Provisional application No. 62/727,829, filed on Sep. 6, 2018.

(30) Foreign Application Priority Data
May 7, 2018 (IN) 201811017083

(51) Int. Cl. G06Q 10/06; G06Q 50/28

(52) U.S. Cl. CPC G06Q 10/063114; G06Q 50/28; G06Q 10/0633; G06Q 10/06316

(57) ABSTRACT

A system for cross-load intermixing during order fulfillment is discussed. Embodiments include mobile devices each associated with a worker, and a fulfillment optimization engine executed by a computing system. The fulfillment optimization engine performs cross-load intermixing by integrating items from later orders into existing task queues while also optimizing picklists for efficient retrieval of items.

### RELATED APPLICATION

This application claims priority to Indian Patent Application No. 201811017083, entitled “Systems and Methods for Cross-Load Intermixing During Order Fulfilment”, filed on May 7, 2018, and to U.S. Patent Provisional Application No. 62/727,829, filed on Sep. 6, 2018, the content of both applications hereby incorporated by reference in their entirety.

### BACKGROUND

In some order fulfilment systems, all customer online orders, apart from rush orders, are received the previous day for the current day's fulfilment. In one approach the received orders are split into time windows based on their respective desired delivery times and the number of delivery vehicles available to transport ‘loads’ of orders during that time window. The items from the loads in each window are assigned to “pickers” who retrieve the items from storage locations in a facility and arrange for their transport to a staging area for loading into delivery vehicles within the applicable time constraint.

### BRIEF DESCRIPTION OF THE DRAWINGS

The accompanying drawings, which are incorporated in and constitute part of this specification, illustrate one or more embodiment of the invention and, together with the description help to explain the invention. The drawings are not intended to be drawn to scale. In the drawings, each identical or nearly identical component that is illustrated in various figures is represented by a like numeral. For purposes of clarity, not every component may be labeled in every drawing. In the drawings:

FIG. 1 illustrates an exemplary system for cross-load intermixing during order fulfillment in accordance with an exemplary embodiment;

FIG. 2 is a flow diagram illustrating a process of cross-load intermixing during order fulfillment in accordance with an exemplary embodiment;

FIG. 3 is a block diagram of an exemplary computational device with various components which can be used to implement an exemplary embodiment; and

FIG. 4 is block diagram of an exemplary distributed system suitable for use in an exemplary embodiment.

### DETAILED DESCRIPTION

Described in detail herein are systems and methods for cross load intermixing during order fulfillment. In one embodiment, an order fulfilment system, receives orders in advance for delivery the next day and provides two levels of inter-twined optimizations: (1) a grouping of items from orders from one or more loads from different time windows; and (2) a pick path of the picker to pick items of these orders. The items from the orders are assigned to a picker based on the time the order is to be complete (e.g.: X minutes before the delivery truck's departure to the customer's address). The items can be assigned based on the location of items in the facility from which they are being retrieved irrespective of the order to which the item belongs. Accordingly entire orders are not necessarily picked at once but rather items from an additional order are picked at the same time that items from other orders are being picked that are in close proximity to those items assuming time constraints are not violated. As part of the assignment of items from different orders to pickers, rules such as, but not limited to, rules specifying which items are not be mixed together and rules indicating which items have temperature constraints are also applied.

As used herein, the following terms have the following meanings:

‘Picking time’ is the time the picker takes for the completion of a trip on which items are collected. The trip consists of the following times:

‘Travel time’ is the time the picker spends travelling from tan originating location to the first pick location, the time traveling between the pick locations and the time from the last pick location to the originating location;

‘Search time’ is the time required for the identification of item;

‘Retrieval time’ is the time needed for moving the items from a storage location onto the picker's tote or trolley.

‘Setup time’ is the time consumed by set-up tasks at the beginning and end of each picker's tour, which may include collection of trolleys/carts, setting up of mobile devices, printers, or other equipment, discussions with supervising personnel, etc.

Order fulfilment is frequently performed in a facility where items remain in the same storage location until they are retrieved and may be de-centralized across several different locations. Conventionally, for each wave of orders within each picking zone (e.g. grocery, frozen, canned goods, general merchandise), order batching is done for only one load/delivery vehicle, where a group of orders from the load are released to the pickers. The picker moves across storage locations to retrieve items and simultaneously picks and sorts the items into customer orders thereby reducing the pick-rate of the picker due to the sorting while picking, but eliminating the need for a downstream sorter. The picker can carry a trolley/cart with totes/baskets/containers and can travel across the facility picking items from locations in a sequence as seen in the picker's pick list. In an embodiment, the picker can then print an order label to be used on the tote etc. (if it's the first item of the order in that pick walk) use a scanner to scan the item, then scan the basket label and then place the item in the basket. The large assortment of items in the fulfillment facility may increase the amount of time needed by the picker to retrieve an item and a mobile scanner that can provide a picture and price of the product may be used to expedite item identification and retrieval. Products that are of high value such as jewelry or electronics or alcohol may have different methods of picking, with only dedicated pickers to do the job. After picking, the retrieved items from the orders are staged in another location until they are loaded onto the delivery vehicle with some level of consolidation and bagging of the orders.

Unfortunately, performing batch ordering for one load at a time in a single time window fails to fully optimize fulfillment processes. Accordingly, embodiments of the present invention address this issue by optimizing fulfillment of multiple orders across multiple time windows while complying with delivery time constraints and fulfillment rules relating to item characteristics and other constraints. More particularly, embodiments assign items from orders due to be delivered in later time windows to batches of items assigned to pickers filling earlier scheduled orders based on the picker's availability, capacity, optimal proximity and the item characteristics.

In one embodiment, multiple orders known before the fulfilment process starts are slotted for delivery throughout the day, and thus the items for these orders can be batched intelligently as pick lists are generated for the picker. Order batching deals with distributing orders across several batches and then sorting/routing the picker(s) efficiently across all locations to pick these orders. The goal is to reduce the total time required to pick all orders on the floor while satisfying the time constraints of the delivery vehicle departures. In an embodiment, the leading metrics are pick rates (Number of items picked/Hour/Picker) and basket Utilization (Number of items/Basket). The system provides a sequence of modular algorithms through which the input orders flows through to finally exit as a number of pick-lists for the pickers.

Embodiments provide order batching optimization not just to optimize picking within each due time of one delivery vehicle load but also to optimize picking for the day across multiple vehicles and due times. A greater number of orders from various due times provides more data points to improve optimization. One caveat to this overall optimization is a bottleneck of the staging area due to space constraint or lack of free totes which is addressed by providing a storage parameter (e.g. maximum number of orders or items that can be stored at a time while awaiting loading onto a delivery vehicle).

In one embodiment, orders of later due times are pulled into earlier established pick lists provided the earlier orders can still be picked on time. Orders from loads of the same due time and of the immediate future are used for order batching. Items of orders from loads with the same due time and from loads of a future due time (partial or in full) can be used for order batching to minimize the overall pick time at a shift or day level. In an embodiment, the number loads and due times to be included from the future are a parameter with more immediate loads given preference for order batching.

The fulfilment system described herein also aims to minimize the total time required for the picker's pick walk, while maximizing the total number of items picked by the picker. In order to facilitate this, N batches of P orders are created each (per commodity type) taking into consideration the due time of the order while batching them. It should be appreciated that a single order will often include multiple items of different commodity types and the items from the different commodity types may be, and usually are, assigned to different pickers operating in different picking zones. The picker's trolley, cart or other retrieval vehicle will usually include multiple totes or containers with each tote or container dedicated to items for a single order for efficiency sake. Once back at a collection/staging area, the totes for an order from different picking zones can be consolidated for delivery together. Orders may be optimized within each individual picking zone (e.g. per commodity type).

In one embodiment, the batching of the orders may be optimized as follows: items from a first customer order are assigned as a single batch. For each additional customer order the system uses proximity and capacity parameters to determine whether it is favorable to pick the items from the additional order separately or to add them into one of the already existing batches assigned to pickers. Put another way, the system determines whether a picker is physically “close enough” to the item (e.g. within a specified distance parameter), has the storage space available on their trolley/cart, and has the time to retrieve it while not violating the time constraints of the previous items the picker has been assigned to retrieve. The output of this approach is batch orders with maximum overlapping of items thereby increasing the density of pick-up points until the capacity of the tote/trolley for a picker is exhausted. Meta-heuristic methods are used to batch orders or work on a subset of orders and greedy and/or other methods are used to optimize the objective function within orders. In one embodiment, if multiple pickers are close enough and all have capacity and time, the system assigns the item from the additional order to the picker that is geographically closest to the item at some point during the performance of their picklist.

In one embodiment, orders are released in multiple waves (e.g.: orders aggregated until 4 am and then dropped at 4 am and orders aggregated from 4 am to 10 am and then dropped at 10 am). Each order has a # delivery vehicle and a due time. Within each due time orders are divided by various commodity types. A fixed number of orders per batch may be specified by commodity type.

A number of assumptions and considerations may be considered by the fulfillment system in performing cross-load intermixing. For example, in one embodiment:

P is the # orders per batch and fixed per commodity.

Order integrity condition; all items of a customer order must be a part of the same batch being assigned to pickers.

All items of P orders would be picked in one trip.

Forward Walk (Service Station to 1st location) & Last Walk (Last item to Service Station) is non-significant and is ignored.

Inter Item walk is the most significant component of the walk.

Seek time is constant for every 1st item but is ignored for overlapping items.

Retrieval time is non-significant and is ignored.

Intra-item walk is calculated by subtracting sequence numbers in the picker's pick list; e.g. A and B are at 1, 7; then the distance between them is 6. The assumption is that each subsequent sequence corresponds to 1 unit.

Customer blocking time is not considered.

The fulfillment system described herein aims to minimize the total time required for the pick walk, while maximizing the total number of items picked. In order to facilitate this, in one embodiment, N batches of P orders each (per commodity type) are created taking into consideration the due time of the order while batching them. The batching of the orders are optimized as follows, it begins with one customer order as a single batch then for each other customer order use proximity to determine whether it is favorable to pick other orders separately or to add them into one of the already existing batches while not violating the trolley capacity. The output of this algorithm will be batch orders with maximum overlapping of items thereby increasing the density of pick-up points until the capacity of the tote/trolley is exhausted. Metaheuristic methods are used to batch orders or work on subset of orders and use greedy/other methods to optimize our objective function within orders. For example, a total trip time for a batch of P orders may be expressed as:

Trip 1: Inter Item Walk for the batch 1+Seek time for batch 1.

Trip 2: Inter Item Walk for the batch 2+Seek time for batch 2.

Trip 3: Inter Item Walk for the batch 3+Seek time for batch 3.

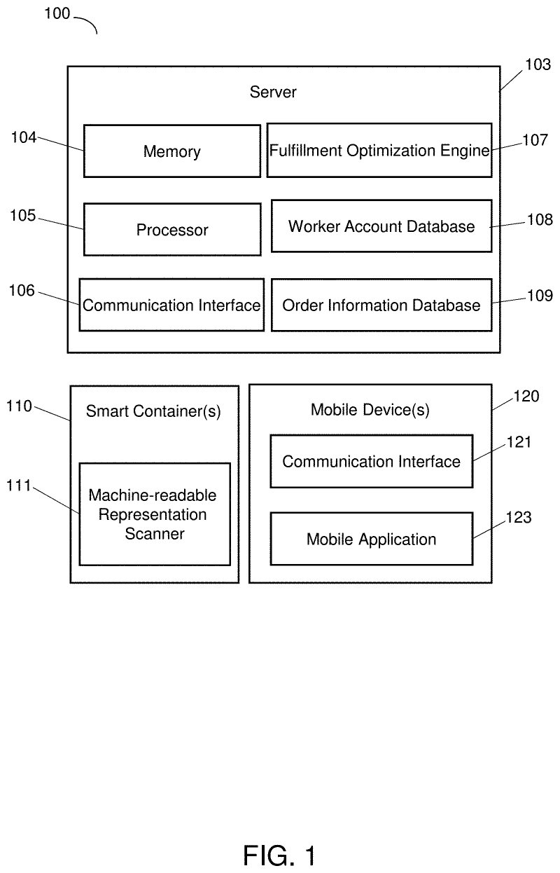

FIG. 1 illustrates an exemplary system for performing cross-load intermixing during order fulfillment in accordance with an exemplary embodiment of the present disclosure. The order fulfillment intermixing system 100 includes a computing device such as server 103. Server 103 includes memory 104, a processor 105 and communication interface 106. Server 103 is configured to execute fulfillment optimization engine 107 and also includes or is able to access a worker account database 108, and order information database 109. Fulfillment optimization engine 107 makes use of communications interface 106 to receive transmitted task completion data from a mobile application 123 executing on a mobile device 120. Fulfillment optimization engine 107 is configured to determine the availability of the worker and assign new tasks to the worker according to the worker's availability. Worker account database 108 includes information associated with the worker or picker, such as the worker's existing task queue. The order information database 109 includes information regarding the placed order and information regarding the items included in each order.

Communication interface 106, in accordance with various embodiments can include, but is not limited to, a radio frequency (RF) receiver, RF transceiver, NFC device, a built-in network adapter, network interface card, PCMCIA network card, card bus network adapter, wireless network adapter, USB network adapter, modem or any other device suitable for interfacing with any type of network capable of communication and performing the operations described herein. Processor 105, in accordance with various embodiments can include, for example, but not limited to, a microchip, a processor, a microprocessor, a special purpose processor, an application specific integrated circuit, a microcontroller, a field programmable gate array, any other suitable processor, or combinations thereof. Server 103 may also include, memory (not shown) such a but not limited to, hardware memory, non-transitory tangible media, magnetic storage disks, optical disks, flash drives, computational device memory, random access memory, such as but not limited to DRAM, SRAM, EDO RAM, any other type of memory, or combinations thereof.

Mobile device 120 includes communication interface 121 for communicating with the server 103 and executes a mobile application 123. Mobile device 120 may be smartphone, tablet or other mobile device equipped with a processor, mobile application 123 and communication interface 121. The mobile application 123 can generate a user interface for accepting user input and may be configured to control an integrated data acquisition device such as, but not limited to, a ON switch to generate an available status indication in response to the worker's operation to the ON switch. Alternatively, as noted above, other techniques such as but not limited to selections received via a user interface provided by mobile application 123 or programmatically generated upon task completion may provide the indication of availability status for a worker. Mobile application 123 transmits the generated availability indication via communication interface 121 to fulfillment optimization engine 107 on server 103. The availability indication indicates to fulfillment optimization engine 107 the availability of the worker. The task queue of each worker may be stored in worker account database 108 or another database.

Smart container 110 can be any container suitable for holding items, such as a tote or trolley with integrated containers. The smart container 110 includes at least one machine-readable representation scanner 111 which can be, as a non-limiting example, a barcode scanner, an RFID reader, an NFC reader, a barcode reader, a digital camera, a mobile device, a magnetic strip reader, a point of sale terminal, any other suitable device, or combinations thereof. When an item is put into the smart container 110, the machine-readable representation scanner 111 scans a machine-readable representation on the item and may transmit a task completion indication to fulfillment optimization engine 107 on server 103. The task completion indication may be sent with each scanned item or only on the last item in an order or batch and may indicate worker availability to fulfillment optimization engine 107. The smart container 110 can also include an integrated transmitter or transceiver for transmitting the task completion indication to fulfillment optimization engine 107. In one embodiment, smart container 110 may have a separate scanner on every interior surface or every interior wall.

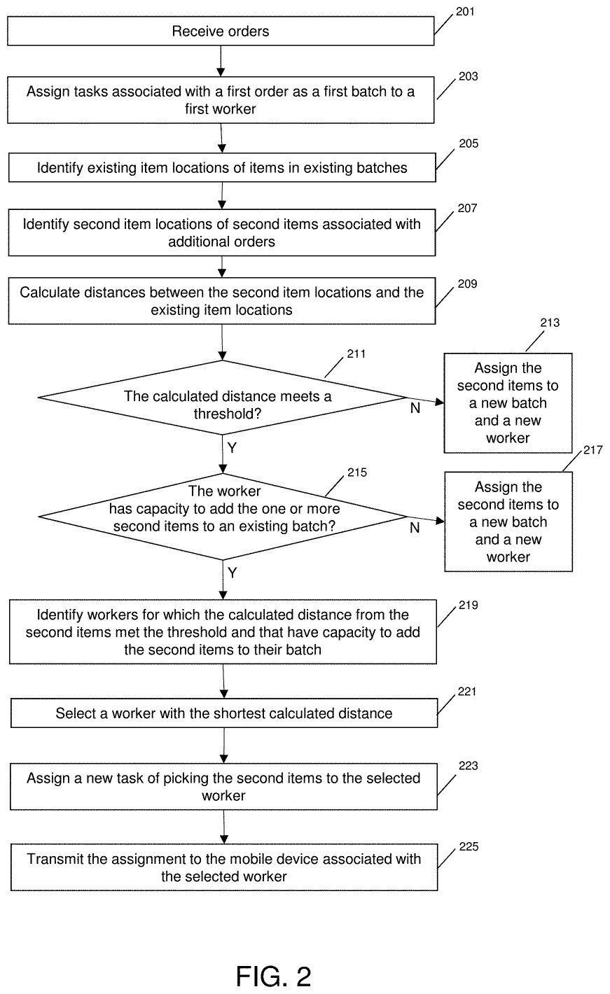

FIG. 2 shows a flow diagram illustrating an exemplary process of fulfilling orders in accordance with various embodiments. In step 201, the fulfillment optimization engine receives one or more orders, and each order is associated with one or more items and has a completion time. For each order, in step 203 the fulfillment optimization engine assigns one or more tasks associated with a first order as a first batch to a first worker of the workers.

Upon receipt of additional orders, for each additional order, in step 205 the fulfillment optimization engine identifies one or more existing item locations of the items in existing batches assigned to available workers. For example, the fulfillment optimization engine may identify each location of each item in a worker's currently existing picklist and may check an availability status of workers in the facility received via the worker's mobile device. In step 207, the fulfillment optimization engine identifies item locations of one or more items associated with the additional order. In step 209, the fulfillment optimization engine calculates the distances between the one or more additional item locations and the existing item locations currently on the pick lists of the workers.

In step 211, the fulfillment optimization engine determines whether each of the calculated distances meets a threshold for each item in the additional order. In step 213, when the calculated distance of the additional item fails to meet the calculated distance threshold for any of the workers (i.e. it is not close enough to be efficiently retrieved given the workers current picklists), the additional item is assigned to a new batch and a new worker. However, when the calculated distance of the additional item meets the calculated distance threshold, in step 215, the fulfillment optimization engine further determines, for each of the workers, the capacity to add the one or more additional items to an existing batch, based at least in part on a volume capacity of a trolley, or other smart containers. In step 217, when the fulfillment optimization engine cannot identify a worker in the group of available workers within the distance threshold that has an available capacity to add the additional items to their existing batch, the additional items are assigned to a new batch and a new worker.

In step 219, for each item that the calculated distance met the threshold, and for which the fulfillment optimization engine identifies one or more workers that have capacity to add the one or more additional items to their existing batch, the fulfillment optimization engine determines whether the additional items can be retrieved without violating a completion time constraint for either the existing items or the one or more additional items.

From among the identified one or more workers who meet the distance threshold, have trolley capacity and can meet the time constraint, in step 221, the fulfillment optimization engine selects a worker with the shortest calculated distance to the one or more additional items among the calculated distances. Then in step 223, the fulfillment optimization engine assigns a new task of picking the one or more additional items to the selected worker. In step 225, the fulfillment optimization engine transmits the assignment of the additional items to the mobile device associated with the selected worker to be added to the existing batch.

It will be appreciated that the sequence of operations performed by the fulfillment optimization engine in FIG. 2 is exemplary and other sequences are possible within the scope of the present invention. For example, even if none of the workers satisfy the distance threshold, in one embodiment, the additional item may still be assigned to a worker who is closest or meets other criteria.

In some embodiments, the one or more tasks include at least one of picking and loading.

In some embodiments, the fulfillment optimization engine further determines whether a staging area has enough staging space for storing the one or more additional items prior to their completion time.

In an embodiment, a mobile device operated by a user may include a mobile application executable on the mobile device, and the mobile application can receive the assignment of the one or more additional items from the fulfillment optimization engine, display a listing of the existing batch of items on the mobile device, and transmit a task completion indication to the fulfillment optimization engine when an existing task is completed.

In some embodiments, the fulfillment optimization engine monitors available capacity of picking units associated with the worker according to a task completion indication received from the mobile devices.

In some embodiments, the fulfillment optimization engine can monitor a current location of the worker based on a location signal received from the mobile device associated with the worker.

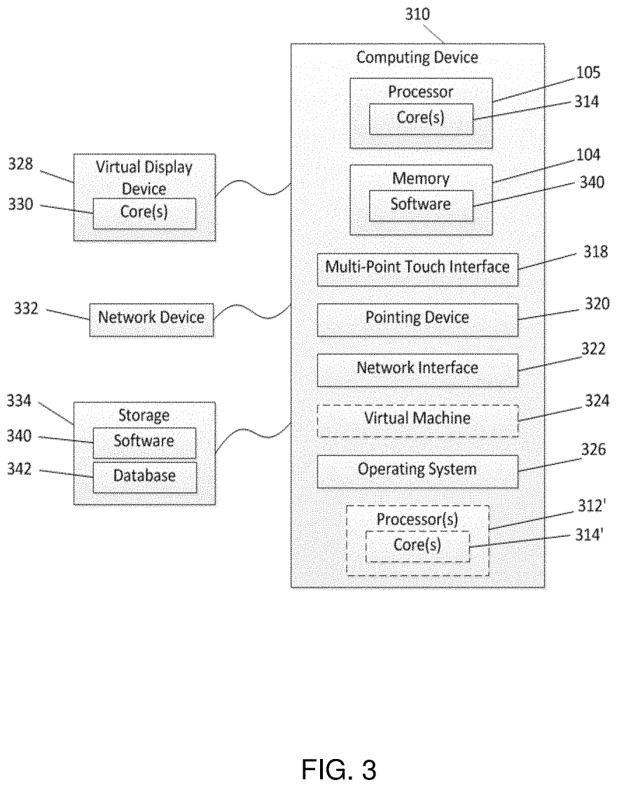

FIG. 3 is a block diagram of an exemplary computing device 310 such as can be used, or portions thereof, in accordance with various embodiments and, for clarity, refers back to and provides greater detail regarding various elements of the system 100 of FIG. 1. The computing device 310, which can be, but is not limited to the server, user mobile device and data capture device described herein, can include one or more non-transitory computer-readable media for storing one or more computer-executable instructions or software for implementing exemplary embodiments. The non-transitory computer-readable media can include, but not limited to, one or more types of hardware memory, non-transitory tangible media (for example, one or more magnetic storage disks, one or more optical disks, one or more flash drives), and the like. For example, memory 104 included in the computing device 310 can store computer-readable and computer-executable instructions or software for performing the operations disclosed herein. For example, the memory 104 can store a software application 340 which is configured to perform the disclosed operations (e.g., optimize order fulfilment). The computing device 310 can also include configurable and/or programmable processor 105 and an associated core 314, and optionally, one or more additional configurable and/or programmable processing devices, e.g., processor(s) 312′ and associated core(s) 314′ (for example, in the case of computational devices having multiple processors/cores), for executing computer-readable and computer-executable instructions or software stored in the memory 104 and other programs for controlling system hardware. Processor 105 and processor(s) 312′ can each be a single core processor or multiple core (314 and 314′) processor.

Virtualization can be employed in the computing device 310 so that infrastructure and resources in the computing device can be shared dynamically. A virtual machine 324 can be provided to handle a process running on multiple processors so that the process appears to be using only one computing resource rather than multiple computing resources. Multiple virtual machines can also be used with one processor.

Memory 104 can include a computational device memory or random access memory, such as DRAM, SRAM, EDO RAM, and the like. Memory 104 can include other types of memory as well, or combinations thereof.

A user can interact with the computing device 310 through a visual display device 328, such as any suitable device capable of rendering texts, graphics, and/or images including an LCD display, a plasma display, projected image (e.g. from a Pico projector), Google Glass, Oculus Rift, HoloLens, and the like, and which can display one or more user interfaces 330 that can be provided in accordance with exemplary embodiments. The computing device 310 can include other I/O devices for receiving input from a user, for example, a keyboard or any suitable multi-point touch (or gesture) interface 318, a pointing device 320 (e.g., a mouse). The keyboard 318 and the pointing device 320 can be coupled to the visual display device 328. The computing device 310 can include other suitable conventional I/O peripherals.

The computing device 310 can also include one or more storage devices 334, such as a hard-drive, CD-ROM, flash drive, or other computer-readable media, for storing data and computer-readable instructions and/or software that perform operations disclosed herein. In some embodiments, the one or more storage devices 334 can be detachably coupled to the computing device 310. Exemplary storage device 334 can also store one or more software applications 340 for implementing processes of the order fulfillment intermixing system described herein and can include databases 342 for storing any suitable information required to implement exemplary embodiments. The databases can be updated manually or automatically at any suitable time to add, delete, and/or update one or more items in the databases. In some embodiments, at least one of the storage device 334 can be remote from the computing device (e.g., accessible through a communication network) and can be, for example, part of a cloud-based storage solution.

The computing device 310 can include a network interface 322 configured to interface via one or more network devices 332 with one or more networks, for example, Local Area Network (LAN), Wide Area Network (WAN) or the Internet through a variety of connections including, but not limited to, standard telephone lines, LAN or WAN links (for example, 802.11, T1, T3, 56kb, X.25), broadband connections (for example, ISDN, Frame Relay, ATM), wireless connections, controller area network (CAN), or some combination of any or all of the above. The network interface 322 can include a built-in network adapter, network interface card, PCMCIA network card, card bus network adapter, wireless network adapter, USB network adapter, modem or any other device suitable for interfacing the computing device 310 to any type of network capable of communication and performing the operations described herein. Moreover, the computing device 310 can be any computational device, such as a workstation, desktop computer, server, laptop, handheld computer, tablet computer, or other form of computing or telecommunications device that is capable of communication and that has sufficient processor power and memory capacity to perform the operations described herein.

The computing device 310 can run operating systems 326, such as versions of the Microsoft® Windows® operating systems, different releases of the Unix and Linux operating systems, versions of the MacOS® for Macintosh computers, embedded operating systems, real-time operating systems, open source operating systems, proprietary operating systems, or other operating systems capable of running on the computing device and performing the operations described herein. In exemplary embodiments, the operating system 326 can be run in native mode or emulated mode. In an exemplary embodiment, the operating system 326 can be run on one or more cloud machine instances.

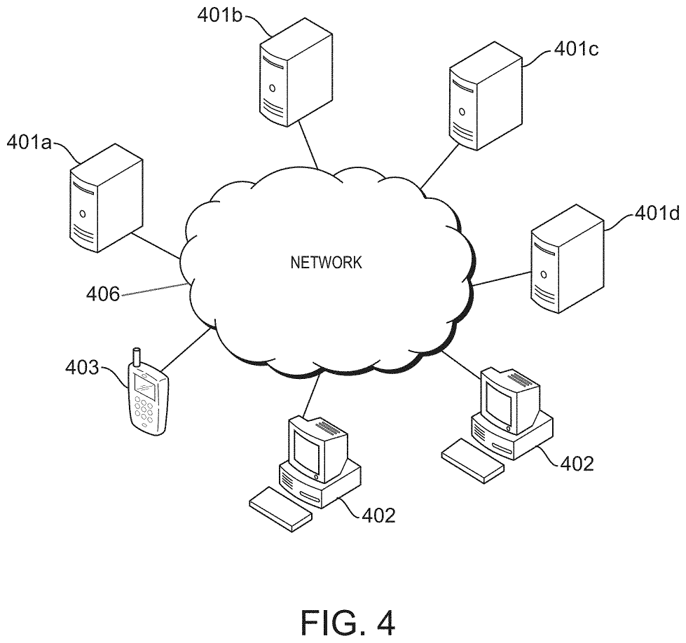

FIG. 4 is a block diagram of exemplary distributed and/or cloud-based embodiments. Although FIG. 1, and portions of the exemplary discussion above, make reference to an order fulfillment intermixing system 100 operating on a single computing device, one will recognize that various of the modules within the order fulfillment intermixing system 100 may instead be distributed across a network 406 in separate server systems 401a-d and possibly in user systems, such as a desktop computer device 402, or mobile computer device 403. As another example, the user interface provided by the mobile application 123 can be a client side application of a client-server environment (e.g., a web browser or downloadable application, such as a mobile app), wherein the fulfillment optimization engine 107 is hosted by one or more of the server systems 401a-d (e.g., in a cloud-based environment) and interacted with by the desktop computer device or mobile computer device. In some distributed systems, the modules of the system 100 can be separately located on server systems 401a-d and can be in communication with one another across the network 406.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a plurality of system elements, device components or method steps, those elements, components or steps may be replaced with a single element, component or step. Likewise, a single element, component or step may be replaced with a plurality of elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the invention. Further still, other aspects, functions and advantages are also within the scope of the invention.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

We claim:

1. A system for cross-load intermixing during order fulfillment, the system comprising:
a plurality of mobile devices each associated with one of a plurality of workers and configured to wirelessly communicate;
a computing system in communication with the plurality of mobile devices, the computing system configured to execute an optimization module that when executed:
receives a plurality of orders, each order associated with a plurality of items and having a completion time;
assigns a plurality of tasks associated with a first order in the plurality of orders as a first batch to a first worker of the plurality of workers;
wherein for each additional order in the plurality of orders the optimization module when executed;
identifies a plurality of existing item locations of a plurality of items in existing batches assigned to the plurality of workers;
identifies second item locations of one or more second items associated with the additional order;
calculates a plurality of distances between the one or more second item locations and the existing item locations;
determines for each item in the additional order whether each of the plurality of calculated distances meets a threshold;
identifies, for each item for which the calculated distance met the threshold, one or more workers from the plurality of workers associated with the existing batch for the existing item for which the calculated distance from the one or more second items met the threshold and that have capacity to add the one or more second items to their batch while not violating a completion time constraint for either the existing items or the one or more second items;
selects a worker from the identified one or more workers that is the worker associated with the existing batch holding the existing item with the shortest calculated distance to the one or more second items among the calculated distances;
assigns a new task of picking the one or more second items to the selected worker; and
transmits the assignment of the one or more second items to the mobile device associated with the selected worker to be added to the existing batch.

2. The system of claim 1, wherein the plurality of tasks include at least one of picking and loading.

3. The system of claim 1, wherein the capacity to add the one or more second items to an existing batch is determined at least in part on a volume capacity of a trolley.

4. The system of claim 1, wherein the one or more second items failing to meet the calculated distance threshold are assigned to a new batch and a new worker.

5. The system of claim 1, wherein the one or more second items are assigned to a new batch and a new worker when a worker with an available capacity to add the one or more second items to their existing batch cannot be identified.

6. The system of claim 1, wherein a determination of capacity by the optimization module determines whether a staging area has enough staging space for storing the one or more second items prior to their completion time.

7. The system of claim 1, further comprising:
a mobile application executable on the plurality of mobile devices, the mobile application when executed configured to:
receive, from the computing system, the assignment of the one or more second items;
display a listing of the existing batch of items on the mobile device; and
transmit, to the computing system, a task completion indication when an existing task is completed.

8. The system of claim 7, wherein the optimization module is further configured to:
monitor available capacity of picking units associated with the worker according to a task completion indication received from the mobile devices.

9. A method for cross-load intermixing during order fulfillment, the method comprising:
receiving, by a computing system in communication with a plurality of mobile devices each being associated with one of a plurality of workers and configured to wirelessly communicate, a plurality of orders, each order associated with a plurality of items and having a completion time;
assigning, by the computing system, a plurality of tasks associated with a first order in the plurality of orders as a first batch to a first worker of the plurality of workers;
for each additional order in the plurality of orders:
identifying, by the computing system, a plurality of existing item locations of a plurality of items in existing batches assigned to the plurality of workers;
identifying, by the computing system, second item locations of one or more second items associated with the additional order;
calculating, by the computing system, a plurality of distances between the one or more second item locations and the existing item locations;
determining, by the computing system, for each item in the additional order whether each of the plurality of calculated distances meets a threshold;
identifying, by the computing system, for each item for which the calculated distance met the threshold, one or more workers from the plurality of workers associated with the existing batch for the existing item for which the calculated distance from the one or more second items met the threshold and that have capacity to add the one or more second items to their batch while not violating a completion time constraint for either the existing items or the one or more second items;
selecting, by the computing system, a worker from the identified one or more workers that is the worker associated with the existing batch holding the existing item with the shortest calculated distance to the one or more second items among the calculated distances;
assigning, by the computing system, a new task of picking the one or more second items to the selected worker; and
transmitting, by the computing system, the assignment of the one or more second items to the mobile device associated with the selected worker to be added to the existing batch.

10. The method of claim 9, wherein the plurality of tasks include at least one of picking and loading.

11. The system of claim 9, further comprising:
determining, by the computing system, the capacity to add the one or more second items to an existing batch, at least in part on a volume capacity of a trolley.

12. The system of claim 9, further comprising:
assigning, by the computing system, the one or more second items failing to meet the calculated distance threshold, to a new batch and a new worker.

13. The system of claim 9, further comprising:
assigning, by the computing system, the one or more second items, to a new batch and a new worker when a worker with an available capacity to add the one or more second items to their existing batch cannot be identified.

14. The system of claim 9, further comprising:
determining, by the computing system, whether a staging area has enough staging space for storing the one or more second items prior to their completion time.

15. The system of claim 9, further comprising:
receiving, by a mobile application executable on the plurality of mobile devices from the computing system, the assignment of the one or more second items;
displaying, by the mobile application, a listing of the existing batch of items on the mobile device; and
transmitting, by the mobile application to the computing system, a task completion indication when an existing task is completed.

16. The system of claim 15, further comprising:
monitoring, by the computing system, available capacity of picking units associated with the worker according to a task completion indication received from the mobile devices.
